(19) United States
(12) Patent Application Publication
(10) Pub. No.: US 2026/0007967 A1
(43) Pub. Date: Jan. 8, 2026

(54) METHOD FOR VIRTUAL PROP PROCESSING, AND NON-TRANSITORY COMPUTER-READABLE STORAGE MEDIUM AND ELECTRONIC DEVICE

(71) Applicant: NETEASE (HANGZHOU) NETWORK CO., LTD., Hangzhou, Zhejiang (CN)

(72) Inventor: Jingyi FU, Guangzhou, Guangdong (CN)

(73) Assignee: NETEASE (HANGZHOU) NETWORK CO., LTD., Hangzhou, Zhejiang (CN)

(21) Appl. No.: 18/881,740

(22) PCT Filed: Feb. 3, 2023
(86) PCT No.: PCT/CN2023/074341

§ 371 Date: Jan. 7, 2025

(30) Foreign Application Priority Data
Jul. 8, 2022 (CN) 202210806246.2

(51) Int. Cl. A63F 13/55; A63F 13/533; A63F 13/822

(52) U.S. Cl. CPC A63F 13/55; A63F 13/533; A63F 13/822

(57) ABSTRACT

A method for virtual prop processing includes: displaying a graphical user interface corresponding to a controlled virtual object corresponding to a terminal device, and receiving a first control operation for a virtual treatment prop through the graphical user interface; in response to the first control operation acting on the virtual treatment prop, determining a target virtual treatment prop, and displaying a target body part of the controlled virtual object corresponding to the target virtual treatment prop in the graphical user interface: and in response to a second control operation for the target body part, determining a body part to be processed of the controlled virtual object from the target body part. performing consumption on the target virtual treatment prop, and performing a game effect corresponding to the target virtual treatment prop on the body part to be processed.

### CROSS REFERENCE TO RELATED APPLICATIONS

The present application is a National Stage Application of International Application No. PCT/CN2023/074341 filed on Feb. 3, 2023 which is based upon and claims priority of the Chinese patent application No. 202210806246.2 filed on Jul. 8, 2022, entitled “Method for virtual prop processing, apparatus, storage medium, and electronic device”, the contents of both of which is incorporated here by reference in its entirety for all purposes.

### TECHNICAL FIELD

The present disclosure relates to the field of game technology, and in particular, to a method for virtual prop processing, an apparatus for virtual prop processing, a computer-readable storage medium, and an electronic device.

### BACKGROUND

In some games, the health, damage or the like of the controlled virtual object located in the game scene are not calculated in an integrated manner, and the body of the controlled virtual object is divided into several parts, and if a local part of the controlled virtual object is damaged, it may be allowed to treat the local part of the controlled virtual object.

In the related art, when treatment is performed on the local part of the controlled virtual object, the virtual treatment prop is usually dragged to the specific part of the model of the controlled virtual object for treatment. However, this manner used in the related art has a certain requirement for the operation precision, the virtual treatment prop needs to be accurately dragged to the part needing to be treated to complete corresponding treatment, the operation path for the game player is longer, and the game player needs to repeatedly perform movement operation between the virtual healing item list and the model of the controlled virtual object. For a control game such as a game using a joystick or a handle, the use difficulty of the virtual treatment prop is relatively greater, and the accuracy is relatively lower.

It should be noted that the information disclosed in the above background section is only used to enhance the understanding of the background of the present disclosure, and therefore may include information that does not constitute the related art known to those of ordinary skill in the art.

### SUMMARY

According to a first aspect of the present disclosure, there is provided a method for virtual prop processing, and the method includes: displaying a graphical user interface corresponding to a controlled virtual object, and receiving a first control operation for a virtual treatment prop through the graphical user interface, where the controlled virtual object corresponds to a terminal device; in response to the first control operation acting on the virtual treatment prop, determining a target virtual treatment prop, and displaying a target body part of the controlled virtual object corresponding to the target virtual treatment prop in the graphical user interface, where the controlled virtual object includes a plurality of body parts, and the target body part is configured for which the target virtual treatment prop to apply to; and in response to a second control operation for the target body part, determining a body part to be processed of the controlled virtual object from the target body part, performing consumption on the target virtual treatment prop, and performing a game effect corresponding to the target virtual treatment prop on the body part to be processed.

According to a second aspect of the present disclosure, there is provided a non-transitory computer-readable storage medium having a computer program stored thereon, where, when the computer program is executed by a processor, the above-mentioned method for virtual prop processing is implemented.

According to a third aspect of the present disclosure, there is provided an electronic device, including: a processor; and a memory, configured to store an executable instruction for the processor, where the processor is configured to perform the method for virtual prop processing by executing the executable instruction.

It is to be understood that both the foregoing general description and the following detailed description are exemplary and explanatory only and are not restrictions of the present disclosure.

### BRIEF DESCRIPTION OF THE DRAWINGS

The accompanying drawings here, which are incorporated in and constitute a part of the description, illustrate embodiments consistent with the present disclosure, and together with the description serve to explain the principles of the present disclosure. Obviously, the accompanying drawings in the following description are merely some embodiments of the present disclosure, and for those of ordinary skill in the art, other drawings may be obtained according to these accompanying drawings without creative efforts.

FIG. 1 shows an example diagram of an interface for use of virtual treatment props in the related art;

FIG. 2 shows a flowchart of a method for virtual prop processing according to one or more embodiments of the present disclosure;

FIG. 3 shows an example diagram of display of a target body part according to one or more embodiments of the present disclosure;

FIG. 4 shows an example diagram of display of a target body part in a scene compatible with an object model according to one or more embodiments of the present disclosure;

FIG. 5 shows an example diagram of display of a target damaged body part according to one or more embodiments of the present disclosure;

FIG. 6 shows an example diagram of display of a target damaged body part including an item for all treatments according to one or more embodiments of the present disclosure;

FIG. 7 shows an example diagram of display of a body part to be processed according to one or more embodiments of the present disclosure;

FIG. 8 shows a flowchart of a preferred example of a method for virtual prop processing according to one or more embodiments of the present disclosure;

FIG. 9 shows a structural block diagram of an apparatus for virtual prop processing according to one or more embodiments of the present disclosure;

FIG. 10 shows an electronic device for implementing the foregoing method for virtual prop processing according to one or more embodiments of the present disclosure.

### DETAILED DESCRIPTION

Example embodiments will now be described more fully with reference to the accompanying drawings. However, the example embodiments can be implemented in a variety of forms and should not be construed as limited to the examples set forth here. By contrast, these embodiments are provided so that the present disclosure will be more comprehensive and complete, and will fully convey the concepts of the example embodiments to those skilled in the art. The described features, structures, or characteristics may be combined in any suitable manner in one or more embodiments. In the following description, numerous specific details are provided to give a thorough understanding of embodiments of the present disclosure. Those skilled in the art will appreciate, however, that the technical solutions of the present disclosure may be practiced without one or more of the specific details, or other methods, components, devices, steps, or the like, may be employed. In other instances, common general known technical solutions are not shown or described in detail to avoid obscuring aspects of the present disclosure.

In addition, the accompanying drawings are merely schematic illustrations of the present disclosure and are not necessarily drawn to scale. The same reference numerals in the figures denote the same or similar parts, and thus their repeated description will be omitted. Some block diagrams shown in the accompanying drawings are functional entities and do not necessarily correspond to physically or logically independent entities. These functional entities may be implemented in software form, or implemented in one or more hardware modules or integrated circuits, or implemented in different networks and/or processor devices and/or microcontroller devices.

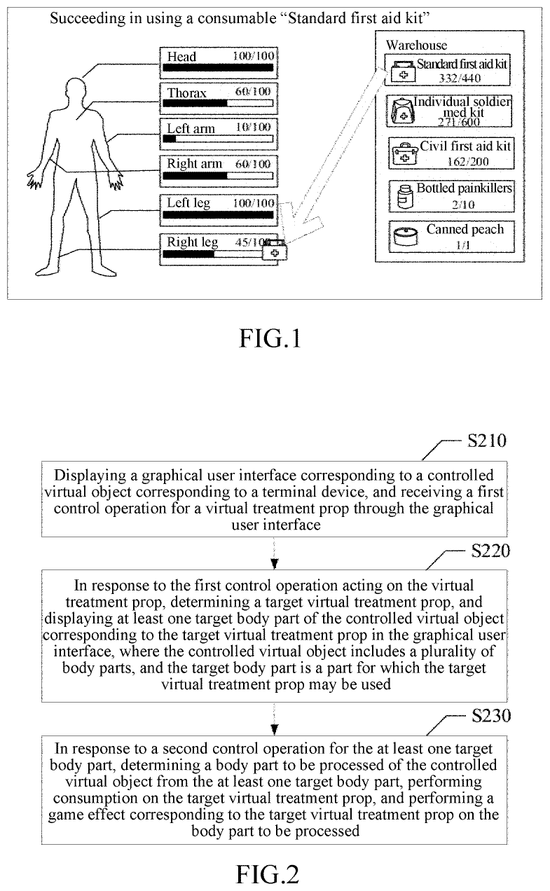

In the related art, when treatment is performed on a local part of the controlled virtual object, a virtual treatment prop is usually dragged to a specific part of a body model of the controlled virtual object, as shown in FIG. 1. If the body part is damaged seriously or there is a plurality of damaged parts, it is difficult to complete the treatment on the part by performing drag once, and a plurality of drag operations need to be performed. The operation path for the game player is longer, the use difficulty of the virtual treatment prop is relatively greater, and the accuracy is relatively lower, which is not applicable to a game interface where there is no body model of a controlled virtual object but treatment needs to be performed. In particular, for a control game such as a game using a joystick or a handle, the drag operation is intended to be converted into an operation of controlling a cursor through a joystick or a handle, and it needs a certain operation level to position the cursor quickly and accurately to a certain position through a joystick or a handle, thus greatly increasing the operation difficulty for the game player.

In view of one or more of the above problems, according to one or more embodiments of the present disclosure, there is provided a method for virtual prop processing, which may be applied to a virtual game scene using a virtual treatment prop, and may meet development requirements of different game platforms at the same time, for example, a game platform such as a mobile phone terminal, a PC (Personal Computer) terminal and a host terminal, and has a relatively higher compatibility.

The method for virtual prop processing according to an embodiment of the present disclosure may run on a local terminal device or a server. When the method for virtual prop processing runs on the server, the method for virtual prop processing may be implemented and performed based on a cloud interaction system, where the cloud interaction system includes a server and a client device.

In some embodiments, various cloud applications may be run in the cloud interaction system, for example, a cloud game. Taking a cloud game as an example, the cloud game refers to a game mode based on cloud computing. In the running mode of the cloud game, the running body of the game program and the game screen presentation body are separated, the storage and running of the method for virtual prop processing are completed on the cloud game server, and the functions of the client device are data receiving, data sending and game screen presentation. For example, the client device may be a display device with a data transmission function close to the user side, such as a mobile terminal, a television, a computer, a palmtop computer, or the like; however, it is the cloud game server on the cloud that performs virtual prop processing. During playing the game, the player operates the client device to send an operation instruction to the cloud game server; and, the cloud game server runs the game according to the operation instruction, encodes and compresses the data such as the game screen, returns the data to the client device through the network, and finally decodes the data and outputs the game screen through the client device.

In some embodiments, taking a game as an example, a local terminal device stores a game program and is configured to present a game screen. The local terminal device is configured to interact with the player through the graphical user interface, that is, to download, install and run a game program conventionally through an electronic device. The manner in which the graphical user interface is provided to the player through the local terminal device may include a plurality of manners. For example, the graphical user interface may be rendered and displayed on a display screen of the terminal, or the graphical user interface may be provided to the player by holographic projection. For example, the local terminal device may include a display screen and a processor; the display screen is configured to present a graphical user interface; the graphical user interface includes a game screen; and the processor is configured to run the game, generate the graphical user interface, and control display of the graphical user interface on the display screen.

In some embodiments, there is provided a method for virtual prop processing, as shown in FIG. 2, which specifically includes the following steps S210 to S230.

In step S210, a graphical user interface corresponding to a controlled virtual object corresponding to a terminal device is displayed, and a first control operation for a virtual treatment prop is received through the graphical user interface.

In step S220, in response to the first control operation acting on the virtual treatment prop, a target virtual treatment prop is determined, and at least one target body part of the controlled virtual object corresponding to the target virtual treatment prop is displayed in the graphical user interface, where the controlled virtual object includes a plurality of body parts, and the target body part is a part for which the target virtual treatment prop may be used.

In In step S230, in response to a second control operation for the at least one target body part, a body part to be processed of the controlled virtual object is determined from the at least one target body part, the target virtual treatment prop is consumed, and a game effect corresponding to the target virtual treatment prop is performed on the body part to be processed.

In the virtual prop processing process, on one hand, the body part to be processed is selected from the target body part for which the target virtual treatment prop may be used, so that targeted use of the target virtual treatment prop is achieved, without depending on the drag operation with a greater difficulty performed by the object model of the virtual object on the virtual treatment prop, the use difficulty of the virtual treatment prop is reduced, the use accuracy and convenience of the virtual treatment prop are improved, thus widening the applicable game type range and improving the compatibility. On the other hand, the target body part for which the target virtual treatment prop may be used is displayed in the graphical user interface, so that the game player can intuitively know the body part for which the target virtual treatment prop may be used, so as to assist the game player in making the use decision of the target virtual treatment prop, thus reducing the time spent by the game player in the process of using the target virtual treatment prop, and accelerating the game process.

It should be noted that the controlled virtual object in the present disclosure refers to a dynamic object that may be controlled in a virtual game scene. The game player may control the controlled virtual object to perform movement in the virtual game scene, for example, may control the controlled virtual object to run, jump, crawl, or the like, and may also control the virtual object to battle with other virtual objects by using a skill, a virtual weapon prop, etc., provided by the application. In addition, the health, damage, or the like of the controlled virtual object are not calculated in an integrated manner, the body model of the controlled virtual object may be divided into several body parts, and each body part is provided with an independent health value. If one or more body parts of the controlled virtual object are damaged, it may be allowed to perform treatment on the damaged body part of the controlled virtual object in a targeted manner. Moreover, the health of different body parts of the controlled virtual object may be different from each other, and the importance degrees of different body parts may also be different from each other. For example, if the leg is damaged, only the moving speed of the controlled virtual object is affected; and if the head is damaged, the controlled virtual object is directly killed.

Each step in FIG. 2 is specifically described below.

In In step S210, a graphical user interface corresponding to a controlled virtual object corresponding to a terminal device is displayed, and a first control operation for a virtual treatment prop is received through the graphical user interface.

The virtual treatment prop may include any one of the following: a virtual treatment prop owned by the controlled virtual object, and a virtual treatment prop scattered in the virtual game scene.

The first control operation may be a click operation for a virtual treatment prop owned by the controlled virtual object or a virtual treatment prop scattered in the virtual game scene.

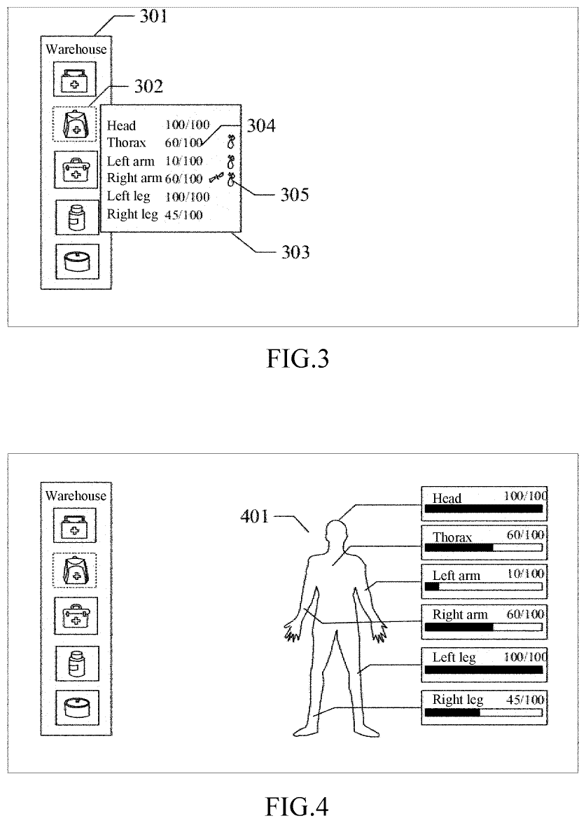

For example, the click operation of the game player for the virtual treatment prop owned by the controlled virtual object may be received through the graphical user interface, and may be responded subsequently. The virtual treatment props are displayed in the warehouse 301 as shown in FIG. 3.

For example, the click operation of the game player for the virtual treatment prop scattered in the virtual game scene may be received through the graphical user interface, and may be responded subsequently.

In step S220, in response to the first control operation acting on the virtual treatment prop, a target virtual treatment prop is determined, and at least one target body part of the controlled virtual object corresponding to the target virtual treatment prop is displayed in the graphical user interface, where the controlled virtual object includes a plurality of body parts, and the target body part is a part for which the target virtual treatment prop may be used.

Taking a game platform on a mobile phone as an example, in response to a touch click operation of the game player on a virtual treatment prop, the virtual treatment prop may be used as the target virtual treatment prop.

Taking a game platform on a PC as an example, when the mouse identifier is suspended on a virtual treatment prop, the virtual treatment prop may be used as the target virtual treatment prop in response to a press and click operation of the game player on the mouse.

Taking a game platform on a host as an example, when a suspension frame is suspended on a virtual treatment prop, the virtual treatment prop may be used as the target virtual treatment prop in response to a press operation of the game player on the triangular key.

For example, as shown in FIG. 3, the virtual treatment prop 302 may be used as the target virtual treatment prop by clicking the virtual treatment prop 302 shown in the warehouse 301. The controlled virtual object may include a plurality of body parts. For example, the controlled virtual object may be divided into several body parts including a head, a left arm, a right arm, a thorax, and a right leg. It should be noted that the division of the body part of the virtual object here is merely an exemplary illustration, and the present disclosure does not specifically limit the body parts included in the controlled virtual object.

The target virtual treatment prop refers to an action object of the first control operation, and the target body part refers to a body part for which the target virtual treatment prop may be used under the division structure of the body model of the controlled virtual object. As shown in the list 303 in FIG. 3, if the virtual treatment prop 302 is selected as the target virtual treatment prop, the body part of the virtual object for which the virtual treatment prop 302 may be used may be displayed in the graphical user interface.

In some embodiments, displaying the at least one target body part of the controlled virtual object corresponding to the target virtual treatment prop in the graphical user interface may be implemented by using the following step: displaying a sub-interface in the graphical user interface, where the sub-interface includes a part item of the at least one target body part. For example, as shown in in FIG. 3, items of a plurality of body part are included in the list 303. In the foregoing steps, the target body part corresponding to the target virtual treatment prop is displayed in the form of the part item, so that it can further get rid of the dependence on the object model of controlled virtual object during the use process of the target virtual treatment prop, thus widening the applicable game type range, and improving the compatibility.

In some embodiments, displaying the at least one target body part of the controlled virtual object corresponding to the target virtual treatment prop in the graphical user interface may also be implemented by using the following step: displaying the at least one target body part of the controlled virtual object corresponding to the target virtual treatment prop according to the display position of the target virtual treatment prop in the graphical user interface.

As shown in the list 303 in FIG. 3, if the virtual treatment prop 302 is selected as the target virtual treatment prop, the target body part corresponding to the target virtual treatment prop may be displayed beside the virtual treatment prop 302, so as to improve the convenience of subsequent control operations.

In some embodiments, displaying the at least one target body part of the controlled virtual object corresponding to the target virtual treatment prop in the graphical user interface may also be implemented by using the following steps: displaying an object model corresponding to the controlled virtual object on the graphical user interface; and displaying the at least one target body part of the controlled virtual object corresponding to the target virtual treatment prop on the object model corresponding to the controlled virtual object.

As shown in FIG. 4, the object model 401 of the controlled virtual object may also be displayed on the graphical user interface, and the target body part corresponding to the target virtual treatment prop may be displayed at the object model 401 of the controlled virtual object, so that the target body part is visualized, thus improving the visual presentation effect.

In some embodiments, if a plurality of target body parts corresponding to the target virtual treatment prop are present in the controlled virtual object, displaying the at least one target body part of the controlled virtual object corresponding to the target virtual treatment prop in the graphical user interface may also be implemented by using the following step: obtaining a target arrangement sequence by sorting the plurality of target body parts of the controlled virtual object corresponding to the target virtual treatment prop; and displaying the plurality of target body parts of the controlled virtual object corresponding to the target virtual treatment prop in the graphical user interface according to the target arrangement sequence.

In the foregoing process, the target body parts are sorted, so that the game player can more intuitively compare the damage conditions of various target body parts of the controlled virtual object, thus the game player preferentially performs treatment on the part with serious damage. In addition, since the current undamaged part of the controlled virtual object does not need to be further treated, before sorting the target body parts for which the target virtual treatment prop may be used, the current undamaged body part in these target body parts may also be filtered.

In some embodiments, obtaining the target arrangement sequence by sorting the plurality of target body parts of the controlled virtual object corresponding to the target virtual treatment prop may be implemented by using the following step: obtaining the target arrangement sequence by sorting target damaged body parts of the controlled virtual object corresponding to the target virtual treatment prop, where the target damaged body parts are damaged body parts in the target body parts.

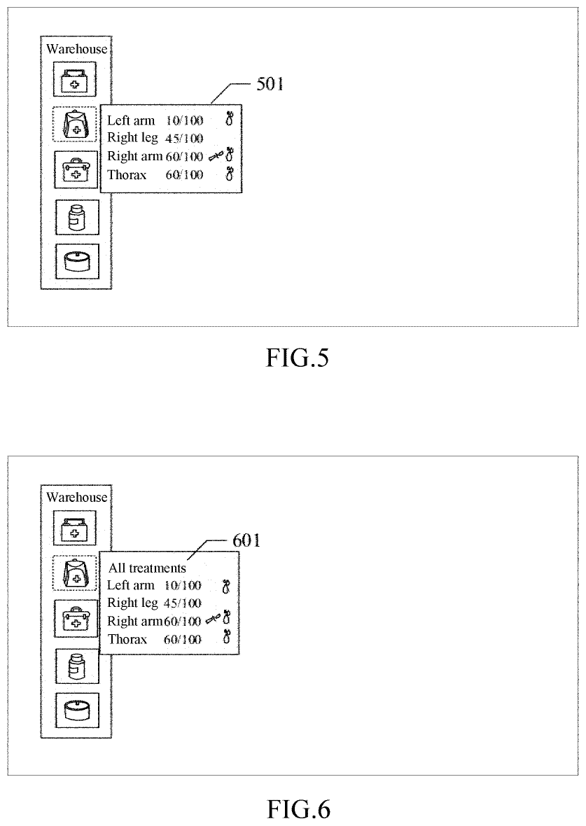

For example, as shown in the list 501 in FIG. 5, the target damaged body parts of the controlled virtual object corresponding to the target virtual treatment prop are sorted, and the undamaged body part in the target body parts does not participate in sorting and displaying. In the above steps, the information displayed on the interface may be further simplified by filtering the current undamaged body part in the target body parts of the controlled virtual object, so as to reduce the visual interference of invalid information to the user as much as possible.

When the target damaged body parts are sorted, the damaged parts that may be treated by using the target virtual treatment prop may be sorted according to one or more of the parameters corresponding to the target damaged body part, such as the damage severity, the importance degree of the part, the damage duration, or the like.

In some embodiments, obtaining the target arrangement sequence by sorting the target damaged body parts of the controlled virtual object corresponding to the target virtual treatment prop may be implemented by using the following step: obtaining the target arrangement sequence by sorting the target damaged body parts according to the damage severities corresponding to the target damaged body parts.

The damage severity of the damaged body part may be represented by the lost health of the damaged part. The more the lost health indicates the higher the damage severity, and the less the lost health indicates the lower the damage severity. In addition, the damage severity of the damaged part may also be represented by the current remaining health of the damaged body part. The more the current remaining health indicates the lower the damage severity; and the less the current remaining health indicates the higher the damage severity. For example, as shown in the list 501 in FIG. 5, the left arm and the right leg have lower remaining health and are arranged with higher sequences. In an actual application process, the parameters representing the damage severity may be specifically set by a developer, which is not specifically limited here.

For the game player, the higher the damage severity of the part, the higher the urgency to use the virtual treatment prop is. Therefore, sorting the damaged parts are based on the damage severity is beneficial to reducing the time spent by the game player to determine the damaged body part that needs to be treated, thus speeding up the game process.

In some embodiments, if body parts with a same damage severity are present in the target damaged body parts, sorting the target damaged body parts according to the damage severities corresponding to the target damaged body parts may be implemented by using the following step: sorting the body parts with the same damage severity in the target damaged body parts according to the damage type.

The damage type of the target damage body part may be benefit-reduced damage, such as bone fracture, bleeding, or the like. For example, as shown in the list 501 in FIG. 5, when the remaining health of the right arm and the remaining health of the thorax are the same, the right arm is subjected to two types of benefit-reduced damages, i.e., bone fracture and bleeding, and the thorax is subjected to one type of benefit-reducing damage, i.e., bleeding, the right arm may be arranged in front of the thorax.

Generally, when there are many damage types to the target damaged body part of the controlled virtual object, the effect on the action of the controlled virtual object in the virtual game scene is relatively significant. In the above steps, the target arrangement sequence is further optimized according to the damage type of the target damaged body part, so as to better comply with the behavior habit of the game player when performing treatment by using the target virtual treatment prop subsequently, and further assist the game player in making a game decision.

In addition, if body parts with a same damage severity are present in the target damaged body parts, the body parts with the same damage severity may also be sorted according to the importance degrees of the parts. For example, when the remaining health of the right arm and the remaining health of the thorax are the same, since the importance degree of the thorax is higher than the importance degree of the arm, the thorax may also be arranged in front of the right arm.

If body parts with a same damage severity are present in the target damaged body parts, the body parts with the same damage severity may also be sorted according to the damage duration. For example, when the remaining health of the right arm and the remaining health of the thorax are the same, if the damage duration of the thorax is longer than the damage duration of the right arm, the thorax may be arranged in front of the right arm.

It should be noted that, in an actual application process, the sorting basis for the body parts with the same damage severity may be specifically set by a developer according to actual requirements, which is not specifically limited here.

In some embodiments, before obtaining the target arrangement sequence by sorting the target damaged body parts according to the damage severities corresponding to the target damaged body parts, the damage severity corresponding to the target damaged body part may also be determined according to the current remaining health value and the total health value corresponding to the target damaged body part.

For example, the damage severity corresponding to the damaged part may be represented by subtracting a ratio of the current remaining health to the total health from 1.

In the foregoing process, the damage severity corresponding to the target damaged body part is quantized based on the health value, so that the target damaged body parts are sorted more accurately, thus further assisting the game player in making a game decision.

In some embodiments, after the target virtual treatment prop is determined, one or more of a damage type, a current remaining health value, and a total health value of the target damaged body part may also be displayed in the graphical user interface.

As shown in FIG. 3, the health identifier 304 of “Current remaining health/Total health” and the damage identifier 305 corresponding to the damage type of the target damaged body part are displayed in the list 303, so as to intuitively prompt the current specific damage condition of the controlled virtual object to the game player, thus facilitating the game player to make further game decision.

With continued reference to FIG. 2, after displaying the target body part in the graphical user interface, the game player may further select the target body part displayed in the graphical user interface.

In In step S230, in response to a second control operation for the at least one target body part, a body part to be processed of the controlled virtual object is determined from the at least one target body part, the target virtual treatment prop is consumed, and a game effect corresponding to the target virtual treatment prop is performed on the body part to be processed.

Taking a game platform on a mobile phone as an example, in response to a touch and click operation of a game player on a target body part, the target body part is used as the body part to be processed.

Taking a game platform on a PC as an example, when the mouse identifier is suspended on a target body part, the target body part is used as the body part to be processed in response to a press and click operation of the game player on the mouse.

Taking a game platform on a host as an example, the game player controls the movement of the suspension frame by performing an up/down/left/right press operation on the cross key or performing a shaking operation on the rocker. When the suspension frame is suspended on a target body part, the target body part is used as the body part to be processed in response to a press operation of the game player on the triangular key.

The second control operation may be a click operation for a target damaged body part in the target body parts or for the target body part. The body part to be processed refers to an action object of the second control operation, and the action object of the second control operation may be one or more, which may be specifically set according to actual requirements, which is not specifically limited here.

In some embodiments, determining the body part to be processed of the controlled virtual object from the at least one target body part in response to the second control operation for the at least one target body part may be implemented by using the following step: determining the body part to be processed of the controlled virtual object from the at least one target body part in response to a third control operation for a part item in the sub-interface.

The third control operation may be a click operation for the target body part or a part item corresponding to the target damaged body part, and the body part corresponding to the part item on which the third control operation is performed may be used as the body part to be processed, so that the targeted use of the target virtual treatment prop is realized, without depending on the drag operation with a greater difficulty performed by the object model of the virtual object on the virtual treatment prop, thus further reducing the use difficulty of the virtual treatment prop.

Any one or more body parts to be processed may be selected from the target body parts through the second control operation or the third control operation. When the game player determines a plurality of body parts to be processed through the second control operation, these body parts to be processed may be processed in batches to further improve the recovery efficiency of the body parts.

In some embodiments, the sub-interface may further include an item for all treatments. Determining the body part to be processed of the controlled virtual object from the at least one target body part in response to the second control operation for the at least one target body part may also be implemented by the following step: in response to a fourth control operation for an item for all treatments, taking all target damaged body parts as body parts to be processed of the controlled virtual object, where the target damaged body part is a damaged body part in the target body parts.

The fourth control operation may be a click operation for an item for all treatments. As shown in FIG. 6, an item of “All treatments” 601 may also be set in the graphical user interface. The target body parts or the target damaged body parts in the target body parts may be used all as the body parts to be processed by clicking the item of “All treatments” located in list of the graphical user interface, so as to further improve the use convenience of the target virtual treatment prop.

In some embodiments, performing consumption on the target virtual treatment prop and performing the game effect corresponding to the target virtual treatment prop on the body part to be processed may be specifically implemented by the following step: updating a current remaining health value corresponding to the body part to be processed according to a treatment value of the target virtual treatment prop until the current remaining health value corresponding to the body part to be processed reaches a total health value or the target virtual treatment prop is exhausted.

The treatment value of the target virtual treatment prop may represent a health value that can be increased by the single target virtual treatment prop to the body part to be processed. For each consumption of one target virtual treatment prop, a corresponding health value may be added on the basis of the current health value of the body part to be processed.

In the foregoing process, the corresponding process may be performed on the body part to be processed by continuously performing consumption on the target virtual treatment prop, for example, restoring the health value of the body part to be processed. The game player does not need to repeatedly drag or click the target virtual treatment prop for treatment, thus simplifying the use operation of the virtual treatment prop, improving the use efficiency of the virtual treatment prop, and accelerating the game process.

In some embodiments, if a plurality of body parts to be processed are present in the controlled virtual object, the above performing consumption on the target virtual treatment prop and performing the game effect corresponding to the target virtual treatment prop on the body part to be processed may also be implemented by using the following steps: performing treatment on the plurality of body parts to be processed of the controlled virtual object sequentially by performing consumption on the target virtual treatment prop according to the target arrangement sequence.

Treatment on the body parts to be processed is performed sequentially according to the target arrangement sequence, so that batch treatment on the damaged parts of the controlled virtual object may be realized, simplifying the operation of the game player, and the body parts to be processed may be processed according to a priority, thus preferentially performing treatment on the body part with serious damage, and relieving the game decision burden of the game player to a certain extent.

In addition, if a plurality of body parts to be processed are present in the controlled virtual object, the damage durations of the body parts to be processed may be counted, and the body parts to be processed may be treated sequentially by performing consumption on the target virtual treatment prop according to the arrangement sequence of the damage durations of the body parts to be processed.

If a plurality of body parts to be processed are present in the controlled virtual object, the body parts to be processed may be treated sequentially by performing consumption on the target virtual treatment prop according to the importance degrees of the body parts to be processed. It should be noted that the treatment sequence of the body parts to be processed may be specifically set by a developer according to actual requirements, which is not specifically limited here.

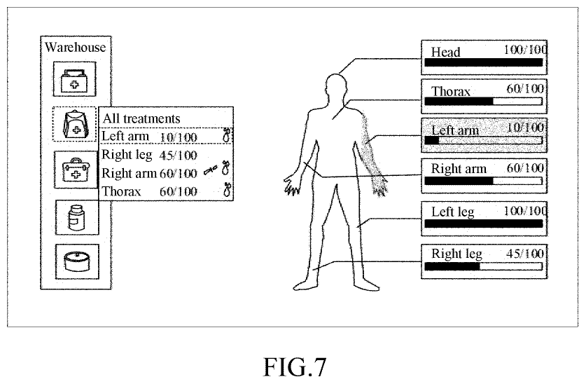

The method for virtual prop processing may further be compatible with the game scene showing the body model of the controlled virtual object as shown in FIG. 7. Specifically, the selected body part to be processed (for example, the “left arm”) may be highlighted in the corresponding part of the body model of the controlled virtual object, and the health value recovery condition during treatment may be updated in real time in the health strip at the corresponding part of the body model, thus enhancing the game interactivity, and further improving the intuition of the game operation.

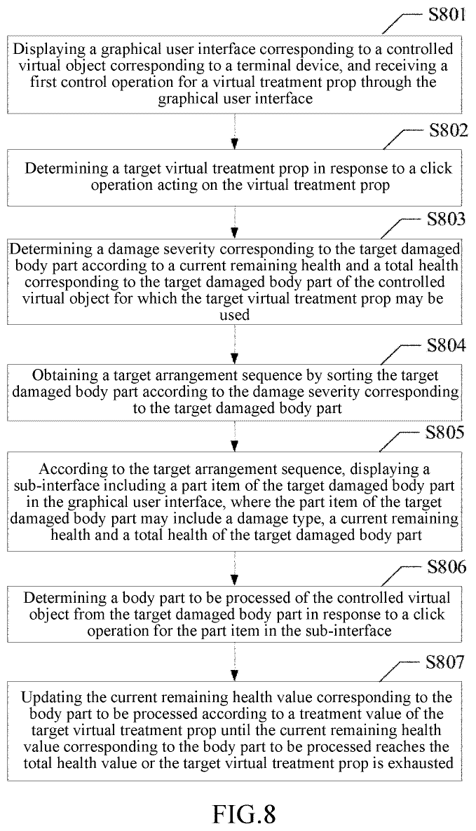

As shown in FIG. 8, there is further provided a flowchart of a preferred implementation of the method for virtual prop processing, in which rapid and accurate treatment of the controlled virtual object may be implemented, effectively improving the accuracy and convenience of the treatment operation of the game player. The method may specifically include the following steps S801 to S808.

In step S801, a graphical user interface corresponding to a controlled virtual object corresponding to a terminal device is displayed, and a first control operation for a virtual treatment prop is received through the graphical user interface.

In step S802, a target virtual treatment prop is determined in response to a click operation acting on the virtual treatment prop.

In step S803, a damage severity corresponding to the target damaged body part is determined according to a current remaining health and a total health corresponding to the target damaged body part of the controlled virtual object for which the target virtual treatment prop may be used.

In step S804, a target arrangement sequence is obtained by sorting the target damaged body part according to the damage severity corresponding to the target damaged body part.

In step S805, according to the target arrangement sequence, a sub-interface including a part item of the target damaged body part is displayed in the graphical user interface, where the part item of the target damaged body part may include a damage type, a current remaining health and a total health of the target damaged body part.

In step S806, a body part to be processed of the controlled virtual object is determined from the target damaged body part in response to a click operation for the part item in the sub-interface.

In In step S807, the current remaining health value corresponding to the body part to be processed is updated according to a treatment value of the target virtual treatment prop until the current remaining health value corresponding to the body part to be processed reaches the total health value or the target virtual treatment prop is exhausted.

On one hand, the target body parts of the virtual object are arranged, so that the body part needing to be treated is selected, and the targeted accurate treatment is achieved; the operation path of the game player is compressed and concentrated, the use difficulty of the virtual treatment prop is reduced, the accuracy and convenience of the treatment operation are improved, thus widening the applicable game type range and improving the compatibility. On the other hand, according to the arrangement sequence of the body parts that may be treated by using the target virtual treatment prop, the body parts that may be treated by using the target virtual treatment prop are displayed in the graphical user interface, so that the game player may more intuitively compare the damage conditions of various body parts of the controlled virtual object, thus facilitating the game player to preferentially perform treatment on the body part with serious damage.

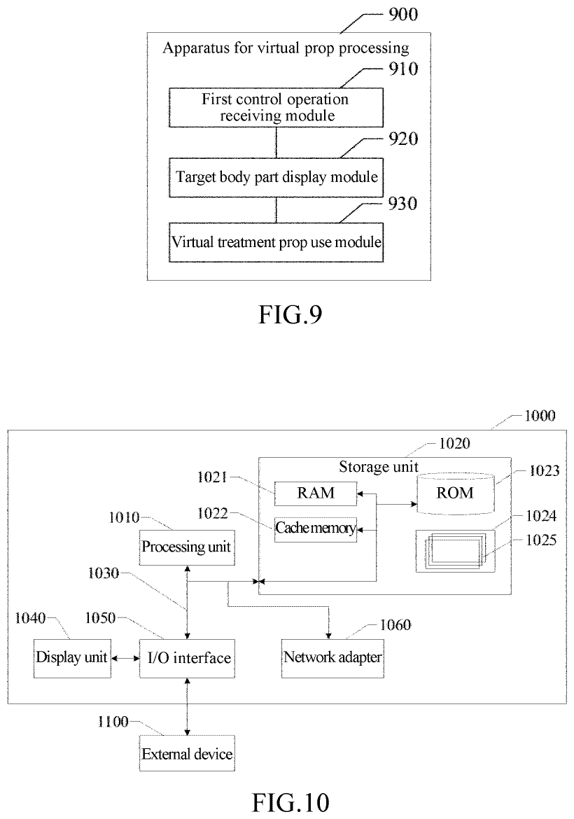

According to one or more embodiments of the present disclosure, there is further provided an apparatus for virtual prop processing. As shown in FIG. 9, the apparatus for virtual prop processing 900 may include a first control operation receiving module 910, a target body part display module 920, and a virtual treatment prop use module 930.

The first control operation receiving module 910 is configured to display a graphical user interface corresponding to a controlled virtual object corresponding to a terminal device, and receive a first control operation for a virtual treatment prop through a graphical user interface. The target body part display module 920 is configured to determine a target virtual treatment prop in response to a first control operation acting on the virtual treatment prop, and display at least one target body part of the controlled virtual object corresponding to the target virtual treatment prop in the graphical user interface, where the controlled virtual object includes a plurality of body parts, and the target body part is a part for which the target virtual treatment prop may be used.

The virtual treatment prop use module 930 is configured to determine a body part to be processed of the controlled virtual object from the at least one target body part in response to a second control operation for the at least one target body part, consume the target virtual treatment prop, and perform a game effect corresponding to the target virtual treatment prop on the body part to be processed.

In some embodiments, the target body part display module 920 that is configured to display at least one target body part of the controlled virtual object corresponding to the target virtual treatment prop in the graphical user interface, may be configured to: display the at least one target body part of the controlled virtual object corresponding to the target virtual treatment prop according to a display position of the target virtual treatment prop in the graphical user interface.

In some embodiments, the target body part display module 920 that is configured to display at least one target body part of the controlled virtual object corresponding to the target virtual treatment prop in the graphical user interface, may be configured to: display an object model corresponding to the controlled virtual object on the graphical user interface; and display the at least one target body part of the controlled virtual object corresponding to the target virtual treatment prop on the object model corresponding to the controlled virtual object.

In some embodiments, the virtual treatment prop in the apparatus for virtual prop processing 900 includes any one of a virtual treatment prop owned by the controlled virtual object, and a virtual treatment prop scattered in a virtual game scene.

In some embodiments, if a plurality of target body parts corresponding to the target virtual treatment prop are present in the controlled virtual object, the target body part display module 920 that is configured to display at least one target body part of the controlled virtual object corresponding to the target virtual treatment prop in the graphical user interface, may further includes: a body part sorting module, configured to obtain a target arrangement sequence by sorting the plurality of target body parts of the controlled virtual object corresponding to the target virtual treatment prop; and a body part display sub-module, configured to display the plurality of target body parts of the controlled virtual object corresponding to the target virtual treatment prop in the graphical user interface according to the target arrangement sequence.

In some embodiments, the body part sorting module further includes a first body part sorting sub-module, configured to obtain the target arrangement sequence by sorting a target damaged body part of the controlled virtual object corresponding to the target virtual treatment prop, where the target damaged body part is a damaged body part in the target body part.

In some embodiments, the first body part sorting sub-module further includes a second body part sorting sub-module, configured to obtain the target arrangement sequence by sorting the target damaged body part according to a damage severity corresponding to the target damaged body part.

In some embodiments, the second body part sorting sub-module may be configured to sort body parts with a same damage severity in the target damaged body part according to a damage type.

In some embodiments, before obtaining the target arrangement sequence by sorting the target damaged body part according to the damage severity corresponding to the target damaged body part, the apparatus for virtual prop processing 900 further includes an damage severity determination module, configured to determine a damage severity corresponding to the target damaged body part according to a current remaining health value and a total health value corresponding to the target damaged body part.

In some embodiments, after determining the target virtual treatment prop, the apparatus for virtual prop processing 900 further includes a body part display sub-module, configured to display one or more of a damage type, a current remaining health value, and a total health value of the target damaged body part in the graphical user interface.

In some embodiments, the virtual treatment prop use module 930 that is configured to consume the target virtual treatment prop and perform the game effect corresponding to the target virtual treatment prop on the body part to be processed, may be configured to: update a current remaining health value corresponding to the body part to be processed according to a treatment value of the target virtual treatment prop until the current remaining health value corresponding to the body part to be processed reaches a total health value or the target virtual treatment prop is exhausted.

In some embodiments, the target body part display module 920 that is configured to display the at least one target body part of the controlled virtual object corresponding to the target virtual treatment prop in the graphical user interface, may be configured to: display a sub-interface in the graphical user interface, where the sub-interface includes a part item of the at least one target body part. The virtual treatment prop use module 930 that is configured to determine the body part to be processed of the controlled virtual object from the at least one target body part, may be configured to: determine the body part to be processed of the controlled virtual object from the at least one target body part in response to a third control operation for the part item in the sub-interface.

In some embodiments, the sub-interface further includes an item for all treatments, and the virtual treatment prop use module 930 that is configured to determine the body part to be processed of the controlled virtual object from the at least one target body part, may be configured to: in response to a fourth control operation for the item for all treatments, take all the target damaged body parts as body parts to be processed of the controlled virtual object, where the target damaged body parts are damaged body part in the target body part.

Specific details of the parts in the apparatus for virtual prop processing 900 have been described in detail in the method embodiments, and the details that are not disclosed may refer to the content of the implementation of the method part, and thus will not be repeated.

According to one or more embodiments of the present disclosure, there is further provided a computer-readable storage medium, on which a program product capable of implementing the method for virtual prop processing described in the description is stored. In some possible implementations, various aspects of the present disclosure may also be implemented in a form of a program product, including program code, and when the program product runs on an electronic device, the program code is used to cause the electronic device to perform the steps described in the foregoing “example method” part of the present specification according to various example embodiments of the present disclosure.

Specifically, the program product stored on the computer-readable storage medium may cause the electronic device to perform the following steps:
displaying a graphical user interface corresponding to a controlled virtual object corresponding to a terminal device, and receiving a first control operation for a virtual treatment prop through the graphical user interface;
in response to the first control operation acting on the virtual treatment prop, determining a target virtual treatment prop, and displaying at least one target body part of the controlled virtual object corresponding to the target virtual treatment prop in the graphical user interface, where the controlled virtual object includes a plurality of body parts, and the target body part is a part for which the target virtual treatment prop may be used; and
in response to a second control operation for the at least one target body part, determining a body part to be processed of the controlled virtual object from the at least one target body part, performing consumption on the target virtual treatment prop, and performing a game effect corresponding to the target virtual treatment prop on the body part to be processed.

In some embodiments, displaying the at least one target body part of the controlled virtual object corresponding to the target virtual treatment prop in the graphical user interface may be implemented by the following step: displaying the at least one target body part of the controlled virtual object corresponding to the target virtual treatment prop according to a display position of the target virtual treatment prop in the graphical user interface.

In some embodiments, displaying the at least one target body part of the controlled virtual object corresponding to the target virtual treatment prop in the graphical user interface may be implemented by the following steps: displaying an object model corresponding to the controlled virtual object on the graphical user interface; and displaying the at least one target body part of the controlled virtual object corresponding to the target virtual treatment prop on the object model corresponding to the controlled virtual object.

In some embodiments, the virtual treatment prop includes any one of a virtual treatment prop owned by the controlled virtual object, and a virtual treatment prop scattered in a virtual game scene.

In some embodiments, if a plurality of target body parts corresponding to the target virtual treatment prop are present in the controlled virtual object, displaying the at least one target body part of the controlled virtual object corresponding to the target virtual treatment prop in the graphical user interface may be implemented by the following steps: obtaining a target arrangement sequence by sorting the plurality of target body parts of the controlled virtual object corresponding to the target virtual treatment prop; and displaying the plurality of target body parts of the controlled virtual object corresponding to the target virtual treatment prop in the graphical user interface according to the target arrangement sequence.

In some embodiments, obtaining the target arrangement sequence by sorting the plurality of target body parts of the controlled virtual object corresponding to the target virtual treatment prop may be implemented by the following step: obtaining the target arrangement sequence by sorting a target damaged body part of the controlled virtual object corresponding to the target virtual treatment prop, where the target damaged body part is a damaged body part in the target body part.

In some embodiments, obtaining the target arrangement sequence by sorting the target damaged body part corresponding to the target virtual treatment prop may be implemented by the following step: obtaining the target arrangement sequence by sorting the target damaged body part according to a damage severity corresponding to the target damaged body part. In some embodiments, sorting the target damaged body part according to the damage severity corresponding to the target damaged body part may be implemented by the following step: sorting body parts with a same damage severity in the target damaged body part according to a damage type.

In some embodiments, before obtaining the target arrangement sequence by sorting the target damaged body part according to the damage severity corresponding to the target damaged body part, the following step may be further performed: determining the damage severity corresponding to the target damaged body part according to a current remaining health value and a total health value corresponding to the target damaged body part.

In some embodiments, after determining the target virtual treatment prop, the following step may be further performed: displaying one or more of a damage type, a current remaining health value, and a total health value of the target damaged body part in the graphical user interface.

In some embodiments, performing consumption on the target virtual treatment prop and performing the game effect corresponding to the target virtual treatment prop on the body part to be processed may be implemented by the following step: updating a current remaining health value corresponding to the body part to be processed according to a treatment value of the target virtual treatment prop until the current remaining health value corresponding to the body part to be processed reaches a total health value or the target virtual treatment prop is exhausted.

In some embodiments, displaying the at least one target body part of the controlled virtual object corresponding to the target virtual treatment prop in the graphical user interface may be implemented by the following step: displaying a sub-interface in the graphical user interface, where the sub-interface includes a part item of the at least one target body part. Determining the body part to be processed of the controlled virtual object from the at least one target body part in response to the second control operation for the at least one target body part may be implemented by the following step: in response to a third control operation for the part item in the sub-interface, determining the body part to be processed of the controlled virtual object from the at least one target body part.

In some embodiments, the sub-interface further includes an item for all treatments; and determining the body part to be processed of the controlled virtual object from the at least one target body part in response to the second control operation for the at least one target body part, may be implemented by the following step: in response to a fourth control operation for the item for all treatments, taking all target damaged body parts as body parts to be processed of the controlled virtual object, where the target damaged body parts are damaged body parts in the target body part.

On one hand, the body part to be processed is selected from the target body part for which the target virtual treatment prop may be used, so that targeted use of the target virtual treatment prop is achieved, without depending on the drag operation with a greater difficulty performed by the object model of the virtual object on the virtual treatment prop, the use difficulty of the virtual treatment prop is reduced, the use accuracy and convenience of the virtual treatment prop are improved, thus widening the applicable game type range and improving the compatibility. On the other hand, the target body part for which the target virtual treatment prop may be used is displayed in the graphical user interface, so that the game player can intuitively know the body part for which the target virtual treatment prop may be used, so as to assist the game player in making the use decision of the target virtual treatment prop, thus reducing the time spent by the game player in the process of using the target virtual treatment prop, and accelerating the game process.

The program product may employ a portable compact disk read-only memory (CD-ROM) and include program code, and may run on an electronic device, such as a personal computer. However, the program product of the present disclosure is not limited to this. In the present document, the readable storage medium may be any tangible medium containing or storing a program, and the program may be used by or used in combination with an instruction execution system, apparatus or device.

The program product may employ any combination of one or more readable medium. The readable medium may be a readable signal medium or a readable storage medium. The readable storage medium may be, for example, but not limited to, an electronic, magnetic, optical, electromagnetic, infrared, or semiconductor system, apparatus, or device, or any combination of the foregoing. A more specific example of the readable storage medium (non-exhaustive list) includes an electrical connection having one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

The computer readable signal medium may include a data signal propagated in a baseband or as part of a carrier, in which readable program code is carried. The propagated data signal may be in various forms, including but not limited to an electromagnetic signal, an optical signal, or any suitable combination of the foregoing. The readable signal medium may also be any readable medium other than the readable storage medium, and the readable medium may send, propagate, or transmit a program for use by or in combination with an instruction execution system, apparatus, or device.

The program code included in the readable medium may be transmitted by using any suitable medium, including but not limited to wireless, wired, optical cable, RF, etc., or any suitable combination of the foregoing.

Program code for performing the operations of the present disclosure may be written in any combination of one or more programming languages, including object-oriented programming languages, such as Java, C++, etc., as well as conventional procedural programming languages, such as the “C” language or similar programming languages. The program code may be executed entirely on the user computing device, partly on the user device, as a stand-alone software package, partly on the user computing device and partly on the remote computing device, or entirely on the remote computing device or server. In the case of involving a remote computing device, the remote computing device may be connected to the user computing device through any type of network, including a local area network (LAN) or a wide area network (WAN), or may be connected to an external computing device (e.g., being connected through the Internet from an Internet service provider).

According to one or more embodiments of the present disclosure, there is further provided an electronic device capable of implementing the above method for virtual prop processing. The electronic device 1000 according to the example embodiment of the present disclosure will be described below with reference to FIG. 10. The electronic device 1000 shown in FIG. 10 is merely an example, and should not bring any limitation to the function and use scope of the embodiments of the present disclosure.

As shown in FIG. 10, the electronic device 1000 may be represented in a form of a general-purpose computing device. Components of the electronic device 1000 may include, but are not limited to, at least one processing unit 1010, at least one storage unit 1020, a bus 1030 connected to different system components (including the storage unit 1020 and the processing unit 1010), and a display unit 1040.

The storage unit 1020 stores program code, and the program code may be executed by the processing unit 1010, so that the processing unit 1010 performs the steps described in the foregoing “example method” part of the present description according to various example embodiments of the present disclosure.

Specifically, the processing unit 1010 may perform the following steps:
displaying a graphical user interface corresponding to a controlled virtual object corresponding to a terminal device, and receiving a first control operation for a virtual treatment prop through the graphical user interface;
in response to the first control operation acting on the virtual treatment prop, determining a target virtual treatment prop, and displaying at least one target body part of the controlled virtual object corresponding to the target virtual treatment prop in the graphical user interface, where the controlled virtual object includes a plurality of body parts, and the target body part is a part for which the target virtual treatment prop may be used; and
in response to a second control operation for the at least one target body part, determining a body part to be processed of the controlled virtual object from the at least one target body part, performing consumption on the target virtual treatment prop, and performing a game effect corresponding to the target virtual treatment prop on the body part to be processed.

In some embodiments, displaying the at least one target body part of the controlled virtual object corresponding to the target virtual treatment prop in the graphical user interface may be implemented by the following step: displaying the at least one target body part of the controlled virtual object corresponding to the target virtual treatment prop according to a display position of the target virtual treatment prop in the graphical user interface.

In some embodiments, displaying the at least one target body part of the controlled virtual object corresponding to the target virtual treatment prop in the graphical user interface may be implemented by the following steps: displaying an object model corresponding to the controlled virtual object on the graphical user interface; and displaying the at least one target body part of the controlled virtual object corresponding to the target virtual treatment prop on the object model corresponding to the controlled virtual object.

In some embodiments, the virtual treatment prop includes any one of a virtual treatment prop owned by the controlled virtual object, and a virtual treatment prop scattered in a virtual game scene.

In some embodiments, if a plurality of target body parts corresponding to the target virtual treatment prop are present in the controlled virtual object, displaying the at least one target body part of the controlled virtual object corresponding to the target virtual treatment prop in the graphical user interface may be implemented by the following steps: obtaining a target arrangement sequence by sorting the plurality of target body parts of the controlled virtual object corresponding to the target virtual treatment prop; and displaying the plurality of target body parts of the controlled virtual object corresponding to the target virtual treatment prop in the graphical user interface according to the target arrangement sequence.

In some embodiments, obtaining the target arrangement sequence by sorting the plurality of target body parts of the controlled virtual object corresponding to the target virtual treatment prop may be implemented by the following step: obtaining the target arrangement sequence by sorting a target damaged body part of the controlled virtual object corresponding to the target virtual treatment prop, where the target damaged body part is a damaged body part in the target body part.

In some embodiments, obtaining the target arrangement sequence by sorting the target damaged body part corresponding to the target virtual treatment prop may be implemented by the following step: obtaining the target arrangement sequence by sorting the target damaged body part according to a damage severity corresponding to the target damaged body part.

In some embodiments, sorting the target damaged body part according to the damage severity corresponding to the target damaged body part may be implemented by the following step: sorting body parts with a same damage severity in the target damaged body part according to a damage type.

In some embodiments, before obtaining the target arrangement sequence by sorting the target damaged body part according to the damage severity corresponding to the target damaged body part, the following step may be further performed: determining the damage severity corresponding to the target damaged body part according to a current remaining health value and a total health value corresponding to the target damaged body part.

In some embodiments, after determining the target virtual treatment prop, the following step may be further performed: displaying one or more of a damage type, a current remaining health value, and a total health value of the target damaged body part in the graphical user interface.

In some embodiments, the above performing consumption on the target virtual treatment prop and performing the game effect corresponding to the target virtual treatment prop on the body part to be processed may be implemented by the following step: updating a current remaining health value corresponding to the body part to be processed according to a treatment value of the target virtual treatment prop until the current remaining health value corresponding to the body part to be processed reaches a total health value or the target virtual treatment prop is exhausted.

In some embodiments, the above displaying the at least one target body part of the controlled virtual object corresponding to the target virtual treatment prop in the graphical user interface may be implemented by the following step: displaying a sub-interface in the graphical user interface, where the sub-interface includes a part item of the at least one target body part. The above determining the body part to be processed of the controlled virtual object from the at least one target body part in response to the second control operation for the at least one target body part may be implemented by the following step: in response to a third control operation for the part item in the sub-interface, determining the body part to be processed of the controlled virtual object from the at least one target body part.

In some embodiments, the sub-interface further includes an item for all treatments; and determining the body part to be processed of the controlled virtual object from the at least one target body part in response to the second control operation for the at least one target body part, may be implemented by the following step: in response to a fourth control operation for the item for all treatments, taking all target damaged body parts as body parts to be processed of the controlled virtual object, where the target damaged body parts are damaged body parts in the target body part.

On one hand, the body part to be processed is selected from the target body part for which the target virtual treatment prop may be used, so that targeted use of the target virtual treatment prop is achieved, without depending on the drag operation with a greater difficulty performed by the object model of the virtual object on the virtual treatment prop, the use difficulty of the virtual treatment prop is reduced, the use accuracy and convenience of the virtual treatment prop are improved, thus widening the applicable game type range and improving the compatibility. On the other hand, the target body part for which the target virtual treatment prop may be used is displayed in the graphical user interface, so that the game player can intuitively know the body part for which the target virtual treatment prop may be used, so as to assist the game player in making the use decision of the target virtual treatment prop, thus reducing the time spent by the game player in the process of using the target virtual treatment prop, and accelerating the game process.

The storage unit 1020 may include a readable medium in the form of a volatile storage unit, for example, a random access storage unit (RAM) 1021 and/or a cache memory storage unit 1022.

The storage unit 1020 may further include a read-only storage unit (ROM) 1023.

The storage unit 1020 may further include a program/utility 1024 having a set of (at least one) program module 1025. Such program module 1025 includes, but is not limited to, an operating system, one or more applications, other program modules, and program data. Each or a certain combination of these examples may include an implementation of a network environment.

The bus 1030 may be one or more of several types of bus structures, including a memory cell bus or a memory cell controller, a peripheral bus, a graphics acceleration port, a processing unit, or a local bus using any of a plurality of bus structures.

The electronic device 1000 may also communicate with one or more external devices 1100 (e.g. a keyboard, a pointing device, a Bluetooth device, etc.), may also communicate with one or more devices that enable a user to interact with the electronic device 1000, and/or may communicate with any device (e.g. a router, modem, etc.) that enables the electronic device 1000 to communicate with one or more other computing devices. Such communication may be performed via an input/output (I/O) interface 1050. In addition, the electronic device 1000 may further communicate with one or more networks (for example, a local area network (LAN), a wide area network (WAN), and/or a public network, such as the Internet) through a network adapter 1060. As shown in the figure, the network adapter 1060 communicates with other modules of the electronic device 1000 via the bus 1030. It should be understood that although not shown in the figure, other hardware and/or software modules may be used in combination with the electronic device 1000, including but not limited to: microcode, a device driver, a redundancy processing unit, an external disk drive array, a RAID system, a tape driver, a data backup storage system, or the like.

Through the description of the foregoing implementations, those skilled in the art may easily understand that the example implementations described here may be implemented by software, or may be implemented by software in combination with necessary hardware. Therefore, the technical solutions according to the embodiments of the present disclosure may be embodied in the form of a software product. The software product may be stored in a non-volatile storage medium (which may be a CD-ROM, a USB flash disk, a mobile hard disk, etc.) or a network, and may include several instructions to cause a computing device (which may be a personal computer, a server, a terminal device, or a network device, etc.) to perform the method according to the example embodiments of the present disclosure.

In addition, the above drawings are merely schematic illustrations of processing included in the method according to the example embodiments of the present disclosure, and are not for the purpose of limiting. It is easy to understand that the processing shown in the above drawings does not indicate or limit the chronological order of these processes. In addition, it is also easy to understand that these processes may be performed synchronously or asynchronously, for example, in a plurality of modules.

It should be noted that although several modules or units of the device for action execution are mentioned in the above detailed description, such division is not mandatory. In fact, according to example embodiments of the present disclosure, the features and functions of two or more modules or units described above may be embodied in one module or unit. Conversely, the features and functions of one module or unit described above may be further divided into a plurality of modules or units.

Those skilled in the art can understand that various aspects of the present disclosure may be implemented as a system, a method, or a program product. Therefore, various aspects of the present disclosure may be specifically implemented in the following form: a complete hardware implementation, a complete software implementation (including firmware, microcode, etc.), or an implementation combining hardware and software, which may be collectively referred to herein as “circuit”, “module” or “system”. Other embodiments of the present disclosure will be apparent to those skilled in the art from consideration of the description and practice of the present disclosure here. The present disclosure is intended to cover any variations, uses, or adaptations of the present disclosure following the general principles of the present disclosure and including the common general knowledge and conventional technical means in the art not disclosed in the present disclosure. It is intended that the description and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope of the present disclosure. The scope of the present disclosure is defined only by the appended claims.

1. A method for virtual prop processing, comprising:
displaying a graphical user interface corresponding to a controlled virtual object, and receiving a first control operation for a virtual treatment prop through the graphical user interface, wherein the controlled virtual object corresponds to a terminal device;
in response to the first control operation acting on the virtual treatment prop, determining a target virtual treatment prop, and displaying a target body part of the controlled virtual object corresponding to the target virtual treatment prop in the graphical user interface, wherein the controlled virtual object comprises a plurality of body parts, and the target body part is configured for the target virtual treatment prop to apply to; and
in response to a second control operation for the target body part, determining a body part to be processed of the controlled virtual object from the target body part, performing consumption on the target virtual treatment prop, and performing a game effect corresponding to the target virtual treatment prop on the body part to be processed.

2. The method according to claim 1, wherein displaying the target body part of the controlled virtual object corresponding to the target virtual treatment prop in the graphical user interface comprises:
displaying the target body part of the controlled virtual object corresponding to the target virtual treatment prop according to a display position of the target virtual treatment prop in the graphical user interface.

3. The method according to claim 1, wherein displaying the target body part of the controlled virtual object corresponding to the target virtual treatment prop in the graphical user interface comprises:
displaying an object model corresponding to the controlled virtual object on the graphical user interface; and
displaying the target body part of the controlled virtual object corresponding to the target virtual treatment prop on the object model corresponding to the controlled virtual object.

4. The method according to claim 1, wherein the virtual treatment prop comprises any one of:
a virtual treatment prop owned by the controlled virtual object, and a virtual treatment prop scattered in a virtual game scene.

5. The method according to claim 1, wherein, displaying the target body part of the controlled virtual object corresponding to the target virtual treatment prop in the graphical user interface comprises:
in response to determining that a plurality of target body parts corresponding to the target virtual treatment prop are present in the controlled virtual object, obtaining a target arrangement sequence by sorting the plurality of target body parts of the controlled virtual object corresponding to the target virtual treatment prop; and
displaying the plurality of target body parts of the controlled virtual object corresponding to the target virtual treatment prop in the graphical user interface according to the target arrangement sequence.

6. The method according to claim 5, wherein obtaining the target arrangement sequence by sorting the plurality of target body parts corresponding to the target virtual treatment prop in the controlled virtual object comprises:
obtaining the target arrangement sequence by sorting a target damaged body part of the controlled virtual object corresponding to the target virtual treatment prop, wherein the target damaged body part is a damaged body part in the target body part.

7. The method according to claim 6, wherein obtaining the target arrangement sequence by sorting the target damaged body part corresponding to the target virtual treatment prop in the controlled virtual object comprises:
obtaining the target arrangement sequence by sorting the target damaged body part according to a damage severity corresponding to the target damaged body part.

8. The method according to claim 7, wherein sorting the target damaged body part according to the damage severity corresponding to the target damaged body part comprises:
sorting body parts with a same damage severity in the target damaged body part according to a damage type.

9. The method according to claim 7, further comprising:
determining the damage severity corresponding to the target damaged body part according to a current remaining health value and a total health value corresponding to the target damaged body part.

10. The method according to claim 9, further comprising:
displaying one or more of a damage type, a current remaining health value, and a total health value of the target damaged body part in the graphical user interface.

11. The method according to claim 1, wherein performing consumption on the target virtual treatment prop and performing the game effect corresponding to the target virtual treatment prop on the body part to be processed comprises:
updating a current remaining health value corresponding to the body part to be processed according to a treatment value of the target virtual treatment prop until the current remaining health value corresponding to the body part to be processed reaches a total health value or the target virtual treatment prop is exhausted.

12. The method according to claim 1, wherein displaying the target body part of the controlled virtual object corresponding to the target virtual treatment prop in the graphical user interface comprises:
displaying a sub-interface in the graphical user interface, wherein the sub-interface comprises a part item of the target body part; and
determining the body part to be processed of the controlled virtual object from the target body part in response to the second control operation for the target body part comprises:
in response to a third control operation for the part item in the sub-interface, determining the body part to be processed of the controlled virtual object from the target body part.

13. The method according to claim 12, wherein the sub-interface further comprises an item for all treatments, and determining the body part to be processed of the controlled virtual object from the target body part in response to the second control operation for the target body part comprises:
in response to a fourth control operation for the item for all treatments, taking all target damaged body parts as body parts to be processed of the controlled virtual object, wherein the target damaged body parts are damaged body parts in the target body part.

14. (canceled)

15. A non-transitory computer-readable storage medium having a computer program stored thereon, wherein when the computer program is executed by a processor, a method for virtual prop processing is implemented, and the method comprises:
displaying a graphical user interface corresponding to a controlled virtual object, and receiving a first control operation for a virtual treatment prop through the graphical user interface, wherein the controlled virtual object corresponds to a terminal device;
in response to the first control operation acting on the virtual treatment prop, determining a target virtual treatment prop, and displaying a target body part of the controlled virtual object corresponding to the target virtual treatment prop in the graphical user interface, wherein the controlled virtual object comprises a plurality of body parts, and the target body part is configured for the target virtual treatment prop to apply to; and
in response to a second control operation for the target body part, determining a body part to be processed of the controlled virtual object from the target body part, performing consumption on the target virtual treatment prop. and performing a game effect corresponding to the target virtual treatment prop on the body part to be processed.

16. An electronic device, comprising:
a processor; and
a memory, configured to store an executable instruction for the processor;
wherein, the processor is configured to perform a method for virtual prop processing by executing the executable instruction, and the method comprises:
displaying a graphical user interface corresponding to a controlled virtual object, and receiving a first control operation for a virtual treatment prop through the graphical user interface. wherein the controlled virtual object corresponds to a terminal device;
in response to the first control operation acting on the virtual treatment prop, determining a target virtual treatment prop, and displaying a target body part of the controlled virtual object corresponding to the target virtual treatment prop in the graphical user interface, wherein the controlled virtual object comprises a plurality of body parts, and the target body part is configured for the target virtual treatment prop to apply to; and
in response to a second control operation for the target body part, determining a body part to be processed of the controlled virtual object from the target body part. performing consumption on the target virtual treatment prop, and performing a game effect corresponding to the target virtual treatment prop on the body part to be processed.

17. The non-transitory computer-readable storage medium according to claim 15, wherein displaying the target body part of the controlled virtual object corresponding to the target virtual treatment prop in the graphical user interface comprises:
displaying the target body part of the controlled virtual object corresponding to the target virtual treatment prop according to a display position of the target virtual treatment prop in the graphical user interface.

18. The non-transitory computer-readable storage medium according to claim 15, wherein displaying the target body part of the controlled virtual object corresponding to the target virtual treatment prop in the graphical user interface comprises:
displaying an object model corresponding to the controlled virtual object on the graphical user interface; and
displaying the target body part of the controlled virtual object corresponding to the target virtual treatment prop on the object model corresponding to the controlled virtual object.

19. The electronic device according to claim 16, wherein, displaying the target body part of the controlled virtual object corresponding to the target virtual treatment prop in the graphical user interface comprises:
in response to determining that a plurality of target body parts corresponding to the target virtual treatment prop are present in the controlled virtual object, obtaining a target arrangement sequence by sorting the plurality of target body parts of the controlled virtual object corresponding to the target virtual treatment prop; and
displaying the plurality of target body parts of the controlled virtual object corresponding to the target virtual treatment prop in the graphical user interface according to the target arrangement sequence.

20. The electronic device according to claim 16, wherein performing consumption on the target virtual treatment prop and performing the game effect corresponding to the target virtual treatment prop on the body part to be processed comprises:
updating a current remaining health value corresponding to the body part to be processed according to a treatment value of the target virtual treatment prop until the current remaining health value corresponding to the body part to be processed reaches a total health value or the target virtual treatment prop is exhausted.

21. The electronic device according to claim 16, wherein displaying the target body part of the controlled virtual object corresponding to the target virtual treatment prop in the graphical user interface comprises:
displaying a sub-interface in the graphical user interface, wherein the sub-interface comprises a part item of the target body part; and
determining the body part to be processed of the controlled virtual object from the target body part in response to the second control operation for the target body part comprises:
in response to a third control operation for the part item in the sub-interface, determining the body part to be processed of the controlled virtual object from the target body part.
